(19) United States
(12) Patent Application Publication
(10) Pub. No.: US 2026/0251615 A1
(43) Pub. Date: Aug. 27, 2026

(54) FLEXIBLE EDDY CURRENT ARRAY INSPECTION PROBE

(71) Applicant: Evident Canada, Inc., Quebec (CA)

(72) Inventor: Benoit Lepage, L’Ancienne-Lorette (CA)

(73) Assignee: Evident Canada, Inc., Quebec (CA)

(21) Appl. No.: 19/549,548

(22) Filed: Feb. 25, 2026

Related U.S. Application Data
(60) Provisional application No. 63/763,037, filed on Feb. 25, 2025.

(51) Int. Cl. G01N 27/90; G01N 27/9013

(52) U.S. Cl. CPC G01N 27/9006; G01N 27/902

(57) ABSTRACT

The present subject matter can include a flexible Eddy Current Array (ECA) probe assembly capable of conforming, without damage to the probe assembly, to complex profiles of structures under test, such as structures having curved portions extending in two orthogonal directions (e.g., where the structure being inspected can have a complex surface curvature in an index axis and in a scan axis). The ECA probe assembly can include slot structures extending through a flexible printed circuit board (PCB) assembly or other substrate, facilitating flexing or bending.

### CROSS REFERENCE TO RELATED APPLICATION

This application claims the benefit of priority under 35 U.S.C. § 119(e) to U.S. Provisional Patent Application No. 63/763,037, filed on February 25, 2025, the entire disclosure of which is hereby incorporated by reference in its entirety.

### BACKGROUND

### Technical Field

This document pertains generally, but not by way of limitation, to apparatus and techniques for non-destructive inspection such as facilitating eddy current inspection, and more particularly, to apparatus and techniques comprising a flexible eddy current array (ECA) sensor assembly that can conform to curved or otherwise complex surface contours.

### Discussion of Art

Non-destructive testing (NDT) can refer to use of one or more different techniques to inspect regions on or within an object, such as to ascertain whether flaws or defects exist, or to otherwise characterize the object being inspected. One class of non-destructive testing can include use of an eddy current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity. Generally, an eddy current (EC) sensor includes one or more sensor elements such as inductive coils that can be excited using an alternating current (AC) source. Such coils (or other electromagnetic sensing elements such as hall sensors) can be used for receiving a signal indicative of an induced eddy current on or within the structure.

### SUMMARY

In one aspect, the present disclosure provides a circuit device for use with an eddy current array (ECA) probe. The device may include a substrate, an array of coils, and conductive traces. The substrate may include a sensing region at a first end portion of the substrate, a routing region at a second end portion of the substrate opposite the first end portion, and an intermediate region extending between the sensing region and the routing region. The array of coils may be defined in and arranged laterally along the sensing region. The conductive traces may be defined in and extend longitudinally along the intermediate and routing regions for coupling the array of coils to a probe connector of the ECA probe. Longitudinal slots may be defined in the intermediate region of the substrate between at least some of the conductive traces to mechanically decouple bending of the sensing region from the routing region.

In one aspect, the present disclosure provides an eddy current array (ECA) sensing assembly. The ECA sensing assembly may include a probe and an acquisition device. The probe may include a circuit board having an array of coils and a resilient backing positionable against a surface of the circuit board. The acquisition device may be operatively couplable with the array of coils to implement a determined timed coil‑stimulation sequence and acquire corresponding eddy‑current signals. The circuit board may further include a substrate and conductive traces. The substrate may include a sensing region at a first end portion of the substrate, and the array of coils may be defined in and arranged laterally along the sensing region. The substrate may further include a routing region at a second end portion of the substrate opposite the first end portion and an intermediate region extending between the sensing region and the routing region. The conductive traces may be defined in and extend longitudinally along the intermediate and routing regions for coupling the array of coils to the acquisition device. Longitudinal slots may be defined in the intermediate region of the substrate between at least some of the conductive traces. The resilient backing may bend the sensing region of the substrate to conform to a contour of a test object when the probe is depressed against the test object. The longitudinal slots may mechanically decouple bending of the sensing region from the routing region

In one aspect, the present disclosure provides a circuit device for use with an eddy current array (ECA) probe. The device may include a substrate, an array of coils, and conductive traces. The substrate may include a sensing region at a first end portion of the substrate, a routing region at a second end portion of the substrate opposite the first end portion, and an intermediate region extending between the sensing region and the routing region. The array of coils may be defined in the sensing region. The conductive traces may be defined in and extend along the intermediate and routing regions for coupling the array of coils to a probe connector of the ECA probe. Longitudinal slots may be defined in the intermediate region of the substrate. A resilient backing of the ECA probe may bend the sensing region of the substrate to conform to a contour of a test object (e.g., when the ECA probe is depressed against the test object). The longitudinal slots may mechanically decouple bending of the sensing region from the routing region.

### BRIEF DESCRIPTION OF THE DRAWINGS

FIG. 1 is a test object with an area that curved along multiple directions, according to at least one embodiment of the present disclosure.

FIG. 2 is a plan view of a circuit device for use with an eddy current array (ECA) probe, according to at least one embodiment of the present disclosure.

FIG. 3 is a detailed view of a portion of the sensing region of the circuit device of FIG. 2, according to at least one embodiment of the present disclosure.

FIG. 4 is a circuit device for use with an eddy current array (ECA) probe including four substrate layers, according to at least one embodiment of the present disclosure.

FIG. 5 is a first layer of the circuit device of FIG. 4, according to at least one embodiment of the present disclosure.

FIG. 6 is a second layer of the circuit device of FIG. 4, according to at least one embodiment of the present disclosure.

FIG. 7 is a third layer of the circuit device of FIG. 4, according to at least one embodiment of the present disclosure.

FIG. 8 is a fourth layer of the circuit device of FIG. 4, according to at least one embodiment of the present disclosure.

FIG. 9 shows an impedance plane representation and imaging showing a flaw indication that may be obtained using an ECA sensing assembly, according to at least one embodiment of the present disclosure.

FIG. 10 is a schematic diagram of an ECA sensing assembly, according to at least one embodiment of the present disclosure.

FIG. 11 is a perspective view of an ECA probe assembly, according to at least one embodiment of the present disclosure.

FIG. 12 is an image showing a printed circuit board of an ECA probe conforming to a complex area of a test object, according to at least one embodiment of the present disclosure.

### DESCRIPTION

Eddy Current Array (ECA) probes can be fabricated using flexible printed circuit board (PCB) materials. Such a flexible assembly can adapt to different surface shapes of structures to be inspected. However, generally-available probes, even if fabricated using flexible PCB materials, may be relatively stiff and may be generally non-stretchable (e.g., such ECA sensors may not be capable of elongation). For example, a generally-available ECA sensor can include a ribbon (e.g., about 2.54 centimeters or about 1 inch wide), and such a configuration can limit an ability for the ECA probe to conform to some surfaces. As an example, generally-available flexible probes may be unable to conform to complex profiles that are concave along a scan axis or to profiles that have curvature in two directions at once (e.g., a turbine blade root area).

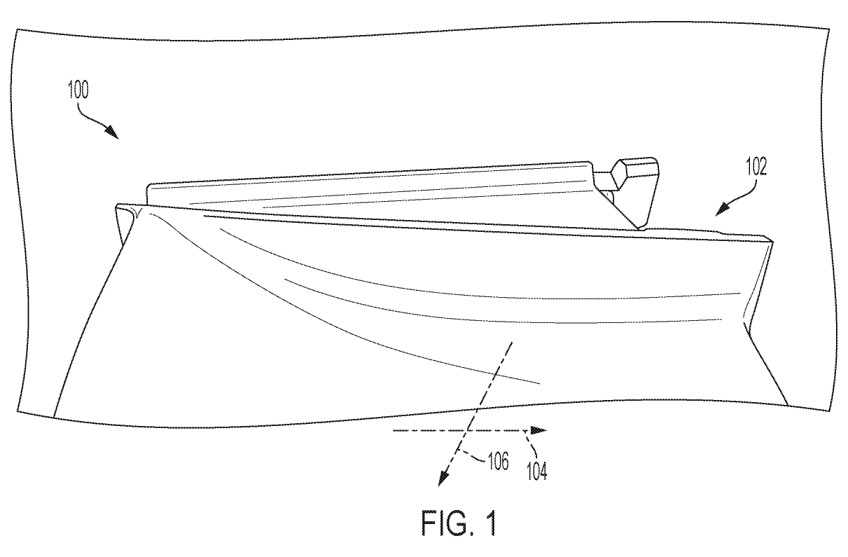

FIG. 1 shows a test object 100 with an area 102 that has a profile with curvature in a first direction 104 and a second direction 106. Generally-available ECA probes may struggle to conform to the profile having curvature in both the first direction and second direction. For example, flexible printed circuit boards (PCB) may bend sufficiently to conform to the curvature in the first direction or the second direction separately. However, the flexible PCB may struggle to bend sufficiently along the curvature in both the first direction and the second direction simultaneously, resulting in portions of the sensing region (e.g., the region of the substrate including the ECA) of the flexible PCB lifting from the surface of test object. This lifting of the sensing region from the test object can result in reduced coupling between the coils and the test object surface, which may degrade the sensitivity and accuracy of the eddy current measurements. In particular, areas of the sensing region that are not in close contact with the test object may experience increased lift-off, leading to diminished signal strength, increased noise, and unreliable detection of flaws or anomalies. Additionally, inconsistent contact across the sensing region may cause variations in the acquired data, making it difficult to interpret inspection results and potentially allowing defects to go undetected.

The present disclosure provides various apparatus and techniques for ECA testing that may address challenges associated with inspecting various surfaces of a test object. For example, the present subject matter includes a flexible ECA probe assembly capable of better conforming, without damage to the probe assembly, to complex profiles that extend in two orthogonal directions (e.g., where the structure being inspected can have a complex surface curvature in an index axis and in a scan axis).

According to various embodiments, the present disclosure provides a circuit device for use with an eddy current array (ECA) probe. The circuit device may be implemented as a printed circuit board (PCB), such as a flexible PCB. Structural aspects of the circuit device can enable the circuit device to conform to complex surfaces of a test object, as discussed further herein.

The circuit device may include an array of coils for generating and detecting eddy currents and conductive traces for electrically coupling the array of coils to a probe connector of an ECA probe and/or to a multiplexer unit integrated to the probe. Coupling of the array of coils to the probe connector can enable the probe and/or an acquisition device to excite the array of coils for generating and detecting eddy currents. In operation, the acquisition device may selectively energize the coils and acquire non-destructive testing (NDT) data from the test object.

The circuit device may include a substrate. The substrate may be formed from flexible materials such as polyimide, which may provide both electrical insulation and mechanical flexibility. Other materials suitable for the substrate may include polyester (PET), polyethylene naphthalate (PEN), liquid crystal polymer (LCP), polytetrafluoroethylene (PTFE), and aramid fibers (Nomex).

The coils and traces may be defined in the substrate using copper or other conductive materials, patterned by photolithography and etching. Other conductive materials suitable for defining the coils and traces may include aluminum, silver, gold, nickel, and conductive alloys such as copper-clad steel.

The substrate may include multiple layers, with coils and traces defined in different layers to optimize electrical performance and mechanical flexibility. Vias may be used to electrically connect traces and coils between layers.

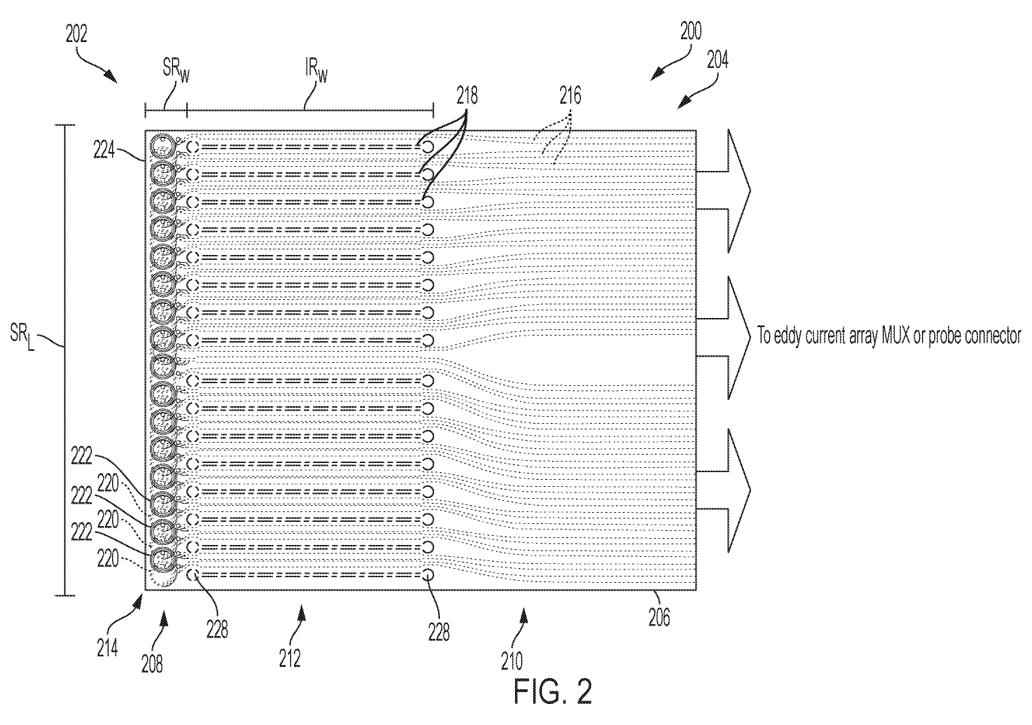

The substrate may include a sensing region located at a first end portion of the substrate. The array of coils may be defined in and arranged laterally along the sensing region. In this context, a coil may be defined by a patterned conductive trace that forms a one or more loops or spiral within the substrate extending across on one or more layers. Arranging the coils laterally can mean that the coils are positioned side-by-side, and in some embodiments at least partially overlapping, extending along a length of the sensing region (e.g., , along SR_{L} as show in the embodiment FIG. 2, along an edge at the first end portion of the substrate). Compared to arrangements where coils are staggered longitudinally, the lateral and partially overlapping arrangement can allow the sensing region to maintain a relatively narrow width (e.g., maintain a narrower SR_{w} as shown in the embodiment of FIG. 2) compared to the sensing region length (e.g., SR_{L}) and the overall lateral width of the substrate (e.g., the width of the substrate defined along the edge of the substrate at the first end portion), concentrating the sensing elements in a compact area.

By arranging the coils in a relatively narrow sensing region, the circuit device can more easily bend concurrently in a first direction along a longitudinal axis of the substrate (e.g., parallel to a scanning direction) and a second direction orthogonal to the longitudinal axis of the substrate. For example, a narrow sensing region in combination with longitudinal slots defined in the substrate, as discussed further herein, may enable the sensing region to be less resistant to concurrent bending along multiple transverse axis, allowing the sensing region to conform to surfaces that are curved in multiple directions. This flexibility can provide adaptability to complex test object surfaces and can enable the sensing region including the coil array to be consistently positioned closer to (e.g., against) the test object surface for improved inspection coverage and sensitivity.

In some embodiments, the array of coils may include an alternating arrangement of first coils and second coils, with portions of the first coils overlapping with portions of the second coils. This arrangement may be implemented by placing a portion of a first coil on one or more layers of the substrate and an overlapping portion of a second coil on one or more different layers. For example, the coils may be formed as coil traces, with the coil traces of the first coils defined in a first subset of the sensing region layers, and the coil traces of the second coils defined in a second subset of the sensing region layers.

In some embodiments, the first coils and second coils may be colinearly aligned along the sensing region. For example, the array of coils including the first coils may be arranged in a straight line or substantially straight line and the second coils may be arranged along the same straight line or substantially straight line as that of the first coils. This linear arrangement can maximize coil coverage within the sensing region while maintaining a narrow width (e.g., compared to non-linear arrangements such as staggered or offset patterns, which may require a wider sensing region and reduce flexibility).

In some implementations, a first subset of the sensing region layers may include two layers, and a second subset of the sensing region layers may comprise two layers positioned between the two layers of the first subset. For example, first coils may be formed in first and fourth layers (e.g., top and bottom layers) of the sensing region, while second coils may be formed on second and third layers (e.g., intermediate layers). This vertical offset can allow the first and second coils to overlap in the sensing region without increasing the overall width of the sensing region. Further, arranging the first coils in the first and fourth layers and second coils in the second and third layers can balance the average lift-off of each coil, resulting in more uniform sensitivity across the array. Thus, this overlapping arrangement can increase coil density and sensitivity, while maintaining a compact sensing region.

In addition to the sensing region, the substrate may include a routing region at a second end portion, opposite the first end portion, and an intermediate region extending between the sensing and routing regions. Conductive traces may be defined in and extend longitudinally along the intermediate and routing regions for electrically coupling the array of coils to the probe connector of the ECA probe. The traces may be patterned conductive lines routed along the substrate, with each coil connected to the probe connector via a dedicated pair of traces. Vias may be used to couple traces and/or coils between layers.

Longitudinal slots may be defined in the intermediate region of the substrate, between at least some of the conductive traces. The longitudinal slots can mechanically decouple bending of the sensing region from the routing region. The slots may be elongated openings that extend parallel to the length of the substrate, and may be arranged in a repeating pattern laterally across the intermediate region. In some embodiments, the slots may extend through all of the substrate layers, forming continuous gaps that pass entirely through the thickness of the substrate. In other embodiments, the slots may pass through only a subset of the substrate layers. The shape of the slots may include elongated portions with curved terminal ends, where the curved ends are wider than the intermediate portions, helping to distribute mechanical stress and prevent tearing at the slot boundaries.

By introducing these longitudinal slots, the substrate may be divided into mechanically independent sections, allowing the sensing region to bend more freely without transmitting mechanical stress to the routing region. This mechanical decoupling can mean that when the sensing region is pressed against a contoured test object, the routing region minimally inhibits or restricts the bending of the sensing region. As a result, the sensing region can maintain close contact with complex surfaces, while the routing region remains relatively unaffected by the deformation, reducing the risk of damage and improving the reliability of the circuit device during inspection.

The substrate may be elongated, with the width (in a lateral direction) being relatively shorter than the length (in a longitudinal direction). The sensing region may be positioned at the first end portion, the routing region at the second end portion, and the intermediate region extends between them. This geometry can allow the sensing region to be concentrated at toward edge of the circuit device, while the routing region provides space for electrical connections and integration with the probe connector.

The sensing region may have a width extending longitudinally from the edge of the first end of the substrate to the intermediate region, and a length extending along the edge of the first end. In some embodiments, the sensing region length is at least five times greater than the sensing region width, such as at least 8 times greater, at least 12 times greater, at least 16 times greater, or at least 32 times greater. The aspect ratio of the sensing region with to the sensing region length may be in a range of 1:5 to 1:32, such as in a range of 1:8 to 1:32. For example, the sensing region may be in a range of 1-5 mm wide and in a range of 5-25 mm in length (e.g., 1 mm wide and 5 mm long, 3 mm wide and 15 mm long, 5 mm wide and 25 mm long). Having the sensing region width narrower than the length can enable better bending in multiple orthogonal dimensions.

The intermediate region may have a width similar to or equal to the length of the longitudinal slots and may extend longitudinally from the sensing region to the routing region. In certain embodiments, the intermediate region width is greater than one‑third of the sensing region length (e.g., IR_{w} > SR_{L}/3). For example, if the sensing region has a length in a range of 5-25 mm, the intermediate region width may be in a range of 2-10 mm (e.g., a sensing region length of 5 mm and an intermediate region width of 2 mm, a sensing region length of 18 mm and an intermediate region width of 10 mm, or a sensing region length of 25 mm and an intermediate region width of 10 mm). The longitudinal slots may have a length greater than one-third of the sensing region length (e.g., slot length > SR_{L}/3). For example, if the sensing region has a length in a range of 5-25 mm, the longitudinal slots may have a length in a range of approximately 2-10 mm (e.g., a sensing region length of 5 mm and a longitudinal slot length of 2 mm, a sensing region length of 18 mm and a longitudinal slot length of 10 mm, or a sensing region length of 25 mm and a longitudinal slot length of 10 mm).

In certain embodiments, the intermediate region width is at least three times greater than the sensing region width. For example, if the sensing region is in a range of 1-5 mm wide, the intermediate region may be in a range of 3-15 mm wide (e.g., 1 mm wide sensing region and 3 mm wide intermediate region, 3 mm wide sensing region and 10 mm wide intermediate region, 5 mm wide sensing region and 15 mm wide intermediate region). The longitudinal slots may have a length at least three times greater than the sensing region width. For example, if the sensing region is in a range of 1-5 mm wide the slots may have a length in a range of 3-15 mm (e.g., 1 mm wide sensing region and 3 mm long slots, 3 mm wide sensing region and 10 mm long slots, 5 mm wide sensing region and 15 mm long slots).

In some embodiments, the substrate may include a structure in which the sensing region is positioned at or near at a longitudinal midpoint of the substrate, with intermediate regions extending outward from opposite sides of the sensing region (e.g., in a mirror-image or approximate mirror-image arrangement). Each intermediate region may include a corresponding set of conductive traces and longitudinal slots, such that the mechanical-decoupling and flexural characteristics described herein are provided on both sides of the sensing region. This arrangement may enable the circuit device to bend or conform in either lateral direction with similar stiffness and deformation response (e.g., for applications requiring bidirectional scanning or where probe orientation relative to the test object may vary). The width and length of the sensing region and the longitudinal slot geometry and/or length of each intermediate region may be similar to the dimensions discussed further herein.

In some embodiments, the intermediate region of the substrate may comprise fewer layers than the sensing region. For example, the sensing region may have four layers to accommodate the overlapping coils, while the intermediate region may have only two layers to increase flexibility and reduce material usage. Pairs of conductive traces corresponding to each coil may run to and from the coils along respective layers of a two-layer intermediate region. The transition in layer count between the intermediate and sensing regions may be achieved using fabrication techniques such as selective lamination, where the sensing region is built up with additional layers, or by step-down routing.

In some embodiments, each coil of the array may be coupled to a pair of conductive traces, with the traces of each pair extending along adjacent layers of the intermediate region in an overlapping arrangement. For instance, send and return traces for a given coil may be routed on two adjacent layers, directly above and below each other, to minimize loop area and reduce electromagnetic interference. Minimizing loop area can reduce the generation of unwanted eddy currents and crosstalk between channels.

In some embodiments, no more than two pairs of conductive traces may be positioned between adjacent longitudinal slots. The traces may be interposed between the longitudinal slots, with each longitudinal slot providing mechanical separation. Having a longitudinal slot between each trace may improve mechanical decoupling. However, adding more longitudinal slots can increase manufacturing effort and complexity. Limiting to no more than two pairs of traces between longitudinal slots can provide sufficient mechanical decoupling while maintaining adequate electrical connectivity. In some embodiments, only one pair of traces may be routed between each longitudinal slot, further enhancing flexibility. In some embodiments, more than two pair of traces may be routed between each longitudinal slot.

In some embodiments, the circuit device may be fabricated using advanced printed circuit board (PCB) manufacturing processes, such as photolithography, chemical or plasma etching, and multi-layer lamination. The substrate may be built up layer by layer, with each layer patterned to define the desired coil and trace geometries. Conductive materials may be deposited using techniques such as electroplating or sputtering and may be followed by etching to create intricate coil and trace patterns. The formation of longitudinal slots may be accomplished using high-precision laser cutting and/or by mechanical punching. The slots may be formed after lamination to ensure they extend through the required number of substrate layers. Additional steps such as drilling and plating may be used to create vias for interlayer electrical connections.

The circuit device may be integrated into an ECA probe assembly, with the sensing region positioned at a probe tip and the routing region connected to a probe connector. A resilient backing, such as a foam or elastomeric material, may be provided to press the sensing region against the test object and ensure conformal contact. The resilient backing may be structured to distribute pressure uniformly across the length and/or width sensing region when pressed against an inspected surface so that the sensing region conforms closely to the inspected surface, even when the surface includes curvature in multiple directions. The resilient backing may be made of materials such as silicone, polyurethane, or other elastomers, selected for their ability to deform under pressure and return to their original shape. Such elastic deformation and recovery may enable the backing to maintain consistent contact forces across the sensing region during use, thereby reducing lift-off variations and improving inspection reliability. The backing may be positioned directly behind the sensing region within the probe assembly, and may be bonded or mechanically fixed to the substrate or probe housing.

During operation, an acquisition device coupled to the circuit device via the probe may implement a timed coil-stimulation sequence, selectively energizing the coils and acquiring corresponding eddy-current signals. A multiplexer (MUX) may be used to select which coils are energized and read at any given time. The MUX may be included in the circuit device itself, for example in the routing region at the second end portion of the circuit device, or may be included in the probe assembly in other embodiments. The acquired data may be processed by the acquisition device to detect flaws, cracks, or other anomalies in the test object. The flexible, decoupled design of the circuit device can enable reliable inspection of surfaces with complex geometries.

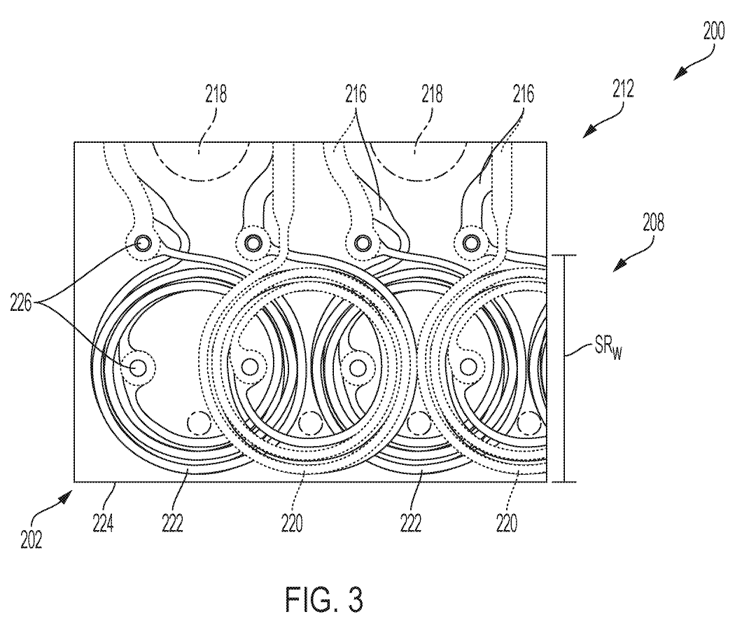

FIG. 2 shows a circuit device 200 for use with an ECA probe and FIG. 3 is a detailed view of a portion of the circuit device of FIG. 2. Aspects of the circuit device of FIGS. 2 and 3 may be implemented in any embodiment of the circuit device and/or ECA probes discussed herein, and vice versa. The circuit device may include a substrate 206 that may extend longitudinally from a first end portion 202 toward a second end portion 204. The first end portion may be positioned proximate one edge of the substrate, and the second end portion may be positioned proximate to an opposite edge of the substrate.

The substrate may be elongated, with a length greater than its width, and may provide both electrical and mechanical support for the components of the circuit device. At the first end portion, the substrate may include a sensing region 208. At the second end portion, the substrate may include a routing region 210. Between the sensing region and the routing region, an intermediate region 212 may extend longitudinally.

An array of coils 214 may be arranged laterally along the sensing region. The coils may be formed by patterned conductive material within the substrate, with each coil positioned side-by-side, partially overlapping with at least one adjacent coil. The coils may be defined on one or more layers of the substrate to achieve a compact arrangement. In some embodiments, the array of coils may include alternating first coils 220 and second coils 222, with portions of the first coils overlapping with portions of the second coils. This overlapping arrangement may be implemented by forming the first coils on one subset of substrate layers and the second coils on a different subset of the substrate layers (e.g., forming the first coils on one subset of sensing region layers and the second coils on a different subset of the sensing region layers). Such a configuration may increase coil density and sensitivity while maintaining the narrow width of the sensing region.

Conductive traces 216 may extend longitudinally along the intermediate region and the routing region. These conductive traces may electrically couple each coil in the array to a probe connector and/or multiplexer of the probe, allowing signals to be transmitted between the coils and external electronics. A pair of traces may correspond to each coil for electrically coupling the coil to the probe, and each trace within the pair may be routed on adjacent layers of the substrate and may overlap vertically to minimize loop area, which can reduce electromagnetic interference and crosstalk. In this context, the “loop area” refers to the effective electromagnetic loop area created by the send and return conductive traces associated with each coil, rather than the physical coil windings themselves. The loop area may represent the size of the current-carrying loop formed by the trace pair. A larger loop area may increase magnetic flux linkage with external fields and can therefore increase susceptibility to induced noise, parasitic eddy currents, and crosstalk between channels. By routing the traces on adjacent layers so that they overlap vertically, the effective loop area of each trace pair can be reduced, which can improve signal integrity and reduce electromagnetic interference.

To enhance mechanical flexibility, longitudinal slots 218 may be defined in the intermediate region, positioned between at least some of the conductive traces. The slots may extend parallel to the length of the substrate and may mechanically decouple bending of the sensing region from the routing region. This decoupling may allow the sensing region to flex separately from the routing region, reducing the transmission of mechanical stress and minimizing the risk of damage during use on complex surfaces. The slots may include curved edges 228 at their terminal ends, which may be wider than the elongated intermediate portions of the slots. This geometry may help distribute mechanical stress and may prevent tearing or cracking of the substrate at the slot ends.

The edge 224 of the substrate may define the boundary of the first end portion, adjacent to the sensing region. Vias 226 may be used throughout the substrate to electrically connect traces and coils between different layers. This may enable complex routing and the implementation of overlapping coil arrangements without increasing the overall width of the sensing region.

A width of intermediate region IR_{w} may be greater than a width of the sensing region SR_{w}, such as for example, at least three times wider, at least four times wider, or at least five times wider. The sensing region width SR_{w} may be relatively narrow compared to a length of the sensing region SR_{L}, which may extend along the edge of the first end portion. For example, the sensing region length SR_{L} may be at least five times longer, at least six times longer, or at least seven times longer. In some embodiments, a width of the intermediate region IR_{w} may be greater than one-third of the sensing region length SR_{L} (e.g., IR_{w} > SR_{L}/3).

FIG. 3 provides a detailed view of a portion of the circuit device, focusing on the sensing region and the arrangement of the array of coils. The lateral arrangement of the coils is shown in FIG. 3, with first coils and second coils positioned in an alternating, colinear fashion along the sensing region. The vias for interlayer connections are also shown.

In various embodiments of in the circuit device of FIG. 2 and FIG. 3, a narrow (e.g., 1.6 millimeter (mm) wide) active area (e.g., sensing region) comprises overlapping eddy current coils fabricated using a multi-layer PCB structure. In this example, a first coil may be formed using conductors on layers 2 and 3 of the substrate while a second coil may be formed using conductors on layers 1 and 4 of the substrate. A series of cuts, such as gaps, holes, slots, or notches (in this example extending 14mm) in the flexible PCB assembly (e.g., longitudinal slots) may be included that decouple the bending of the sensitive coil area (e.g., the sensing region) from the bulk of the remaining flexible circuit assembly (e.g., the routing region), particularly a region distal to the sensitive coil area located on the opposite end of the circuit assembly. The regions at the terminus of respective cuts may be curved such as to reduce a potential concentration of mechanical stress in those locations under deformation. Such features can inhibit or prevent tearing, delamination, or other mechanical damage to the sensor assembly.

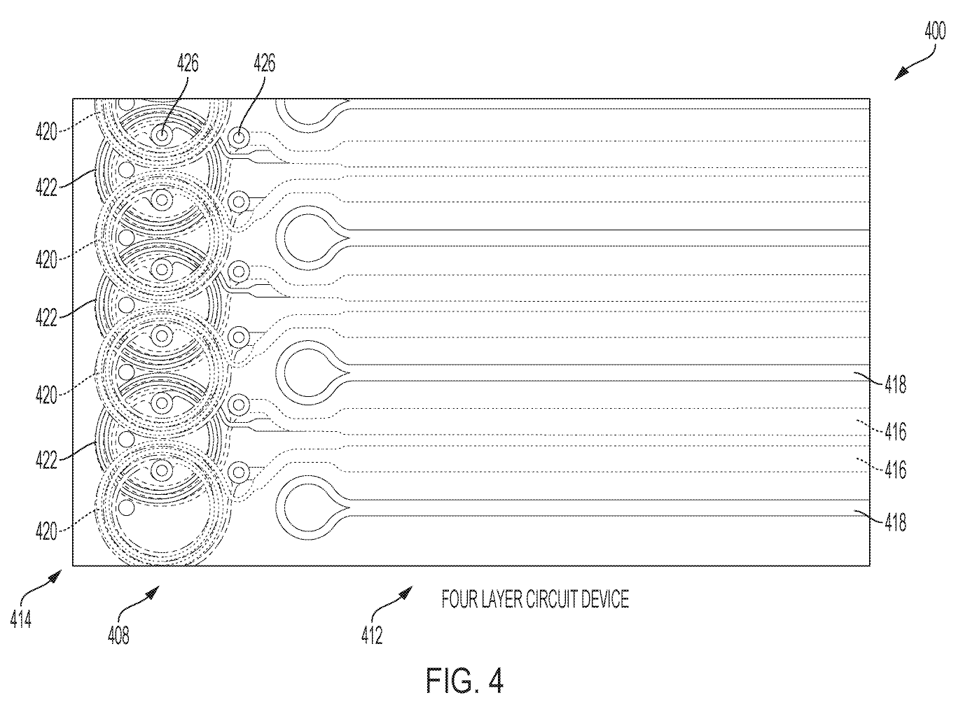

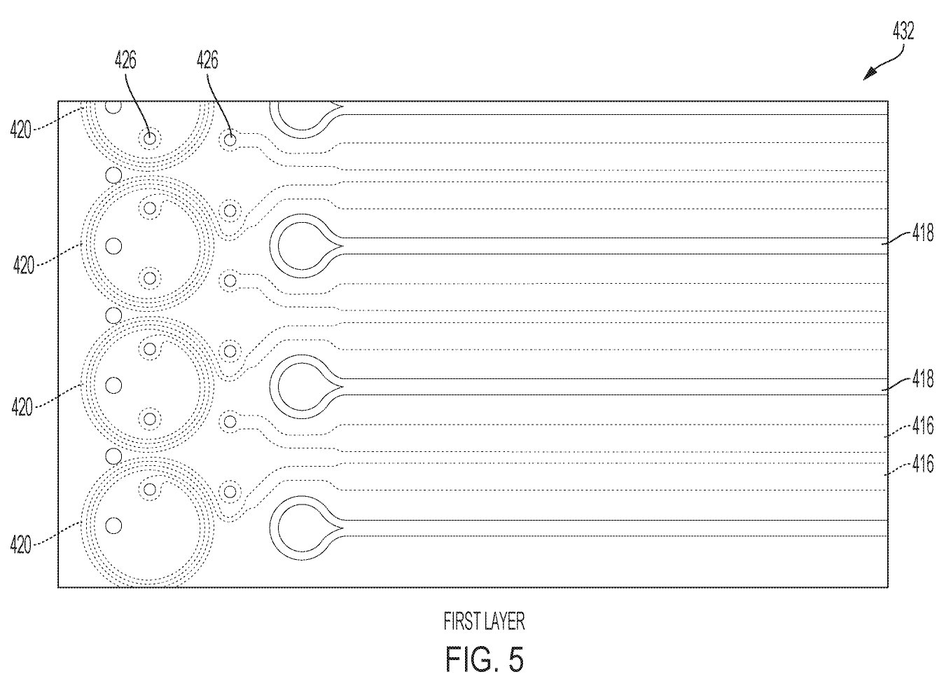

FIG. 4 is a circuit device 400 for use with an eddy current array (ECA) probe including four substrate layers. FIG. 4 shows the four substrate layers superimposed on one another and each of FIGS. 5-8 shows a different one of the four layers. FIG. 4 is similar in many aspects to the circuit device of FIG. 2. Any aspect disclosed with respect to the circuit device of FIG. 4 may be included in the embodiment of the circuit device of FIG. 2 and vice versa. The circuit device of FIG. 4 includes a sensing region 408, an intermediate region 412, and an array of coils 414. The array includes first coils 420 and second coils 422. The circuit device also includes conductive traces 416 and longitudinal slots 418. Vias 426 are included to couple coil portions and/or conductive traces between layers. Although a four-layer arrangement is illustrated in the non-liminting embodiment of FIG. 4, this configuration is not intended to be limiting. Other embodiments may employ a greater or lesser number of substrate layers. For example, a two-layer or three-layer substrate may be used in simpler constructions, or a five-layer, six-layer, or higher-layer substrate may be used in embodiments requiring additional routing density, shielding, or mechanical tuning. The particular number of layers used may vary depending on design requirements and is not restrictive unless expressly stated.

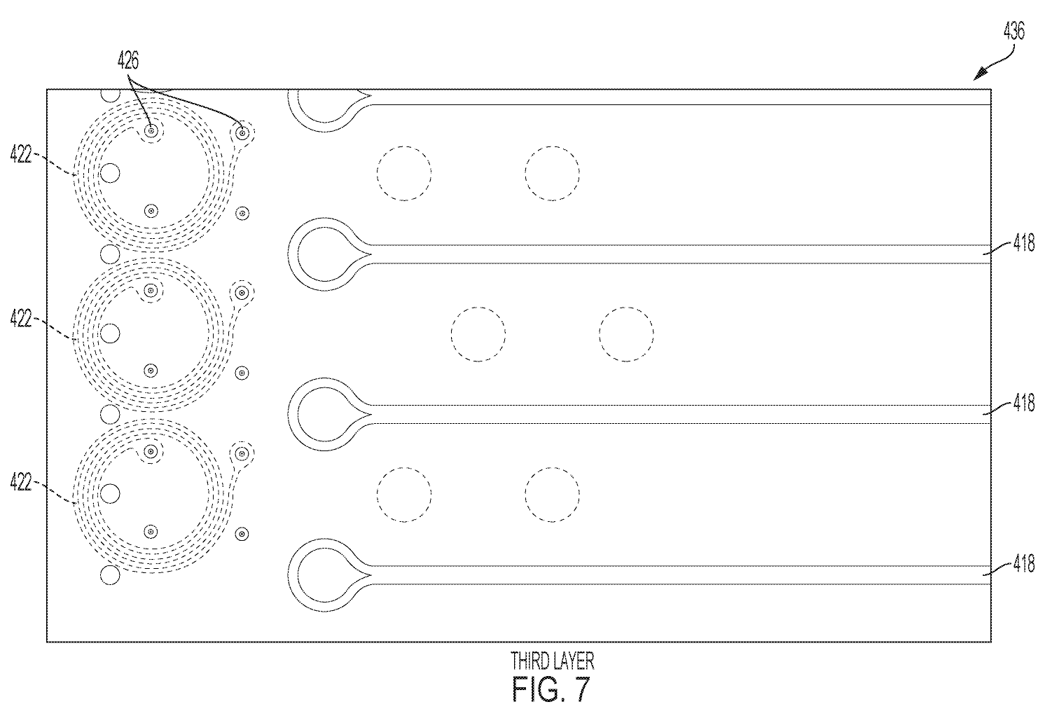

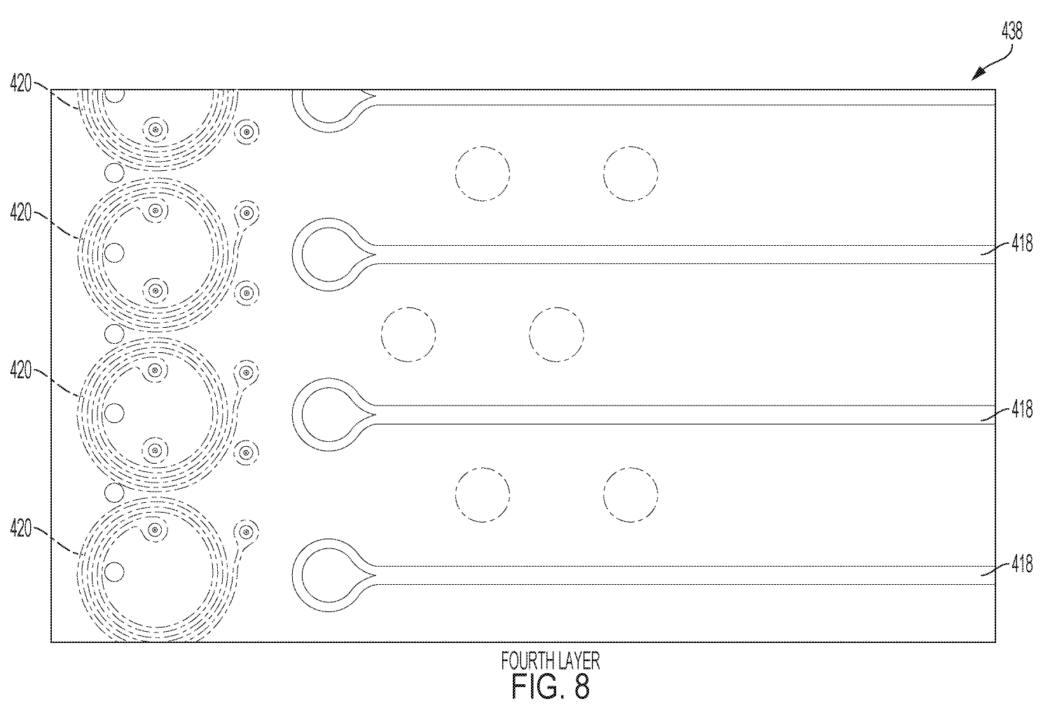

FIG. 5 is a first layer 432 of the circuit device of FIG. 4. As shown in FIG. 5 multiple winds of the first coils are defined in the first layer. Vias are used to couple winds of the first coils in the first layer to winds of the first coils in the fourth layer, shown in FIG. 8. Conductive traces are defined in the first layer and coupled to winds of the first coils defined in the first layer. Conductive traces in the first layer also run to vias for coupling to winds of the second coils defined in the third layer, shown in FIG. 7.

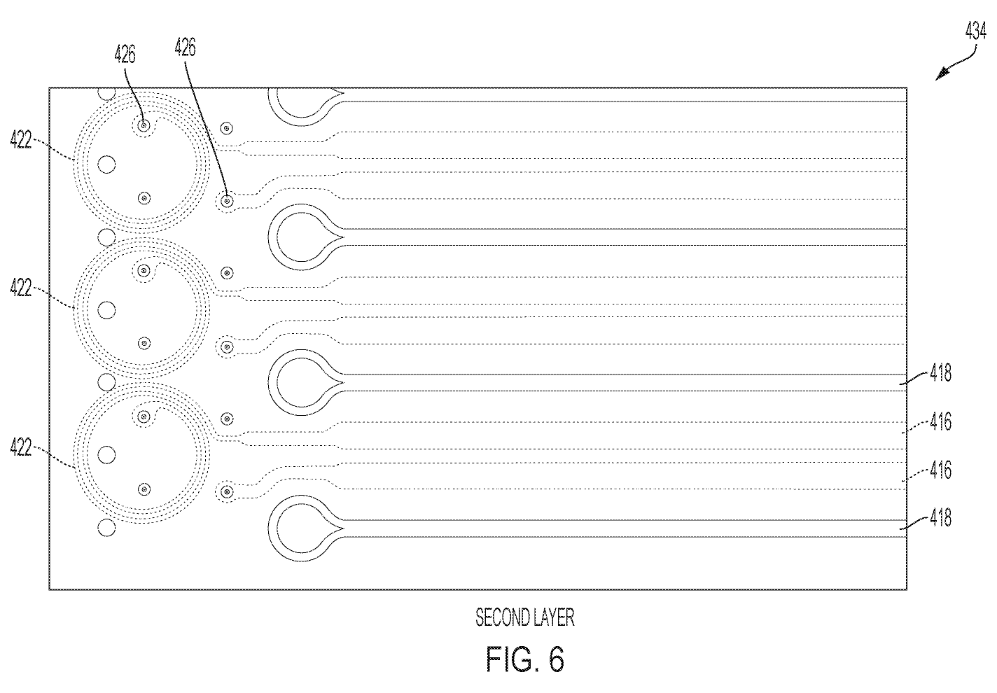

FIG. 6 is a second layer 434 of the circuit device of FIG. 4. As shown in FIG. 6, multiple winds of the second coils are defined in the second layer. Vias are used to couple winds of the second coils in the second layer to winds of the second coils defined in the third layer, shown in FIG. 7. Conductive traces are defined in the second layer and couple to winds of the second coils defined in the second layer. Conductive traces in the second layer also run to vias for coupling to winds of the first coils defined in the fourth layer, shown in FIG. 8.

FIG. 7 is a third layer 436 of the circuit device of FIG. 4. As shown in FIG. 7, multiple winds of the second coils are defined in the third layer. The winds of the second coils defined in the third layer are coupled to corresponding winds of the second coils defined in the second layer at vias. The other ends of the winds of the second coils defined in the third layer are coupled to conductive traces in the first layer at vias.

FIG. 8 is a fourth layer 438 of the circuit device of FIG. 4. As shown in FIG. 8, multiple winds of the first coils are defined in the fourth layer. The winds of the second coils defined in the fourth layer are coupled to corresponding winds of the first coils defined in the first layer at vias. The other ends of the winds of the first coils defined in the fourth layer are coupled to conductive traces in the second layer at vias.

Thus, as shown in FIGS. 4-8, the first coils are defined in the first layer and the fourth layer, and traces for coupling the first coils with a probe are defined in the first layer and the second layer. Furthermore, each pair of traces corresponding to the first coils overlap one another as they run along their respective first and second layers of the substrate. The second coils are defined in the second layer and the third layer, and traces for coupling the second coils with a probe are defined in the first layer and the second layer. Furthermore, each pair of traces corresponding to the second coils overlap one another as they run along their respective first and second layers of the substrate.

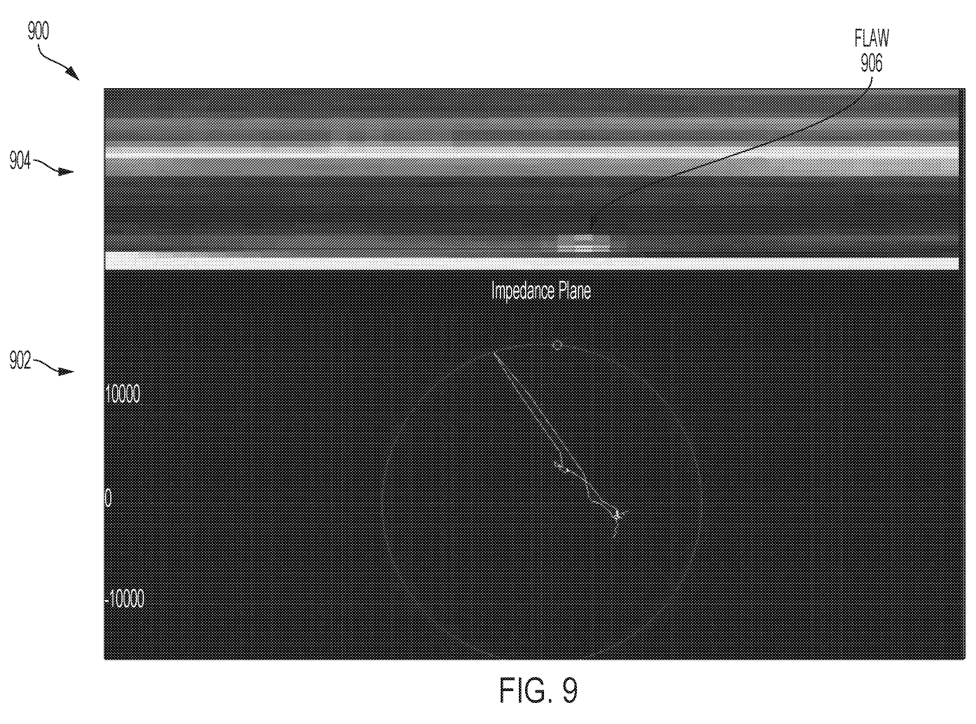

FIG. 9 shows experimental test data 900 including an impedance plane 902 and corresponding imaging 904 illustrating a flaw indication 906 obtained using an ECA sensing assembly according to an embodiment of the present disclosure. In this example, the test object is a turbine blade having a surface profile with curvature in multiple directions, presenting a challenging inspection scenario for conventional probes. The impedance plane displays the response of the ECA probe as it scans the test object, with the flaw indication appearing as a distinct deviation or feature in the impedance data. The corresponding imaging provides a spatial representation of the flaw’s location and size on the test object.

The flaw indication shown in FIG. 9 demonstrates the enhanced sensitivity and coverage that can be provided by the described ECA sensing assembly. In contrast, traditional eddy current array devices may struggle to maintain adequate contact with surfaces exhibiting curvature in multiple directions, leading to areas of the sensing region lifting from the surface and a corresponding loss of sensitivity. As a result, flaws such as the one indicated in FIG. 9 may remain undetected with conventional probes.

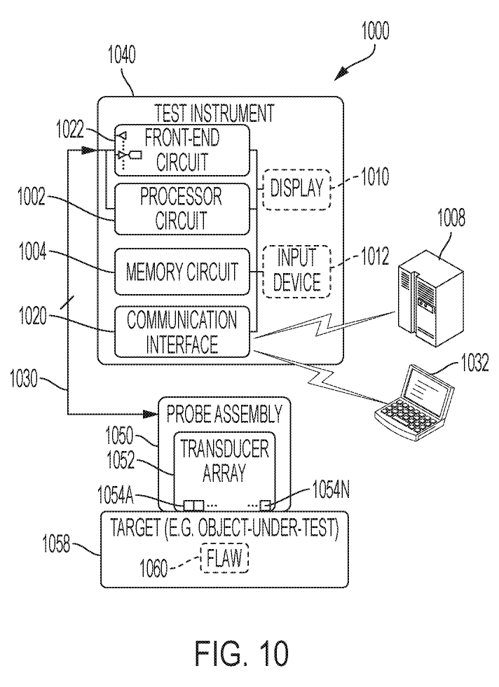

FIG. 10 is a schematic diagram of an ECA sensing assembly 1000. The sensing assembly can include a test instrument 1040 (e.g., an acquisition device), such as a hand-held or portable assembly. The test instrument can be electrically coupled to a probe assembly 1050, such as using a multi-conductor interconnect 1030. The probe assembly can include one or more transducers, such as an eddy current (EC) transducer array 1052 including respective EC sensors 1054A through 1054N. The transducers array can follow a linear or curved contour or can include an array of elements extending in multiple axes. In some embodiments, the probe assembly may include or otherwise be coupled with embodiments of the circuit devices disclosed herein (e.g., including an array of coils as the EC sensors).

A modular probe assembly can be used, such as to allow a test instrument to be used with various different probe assemblies. Generally, the transducer array may include EC coils, such as located on or within a substrate. The EC coils are electromagnetically coupled with a target 1058 (e.g., a test specimen or “object-under-test”). The test instrument can include digital and analog circuitry, such as a front-end circuit including one or more transmit signal chains, receive signal chains, or switching circuitry (e.g., transmit/receive switching circuitry). The transmit signal chain can include amplifier and filter circuitry, such as to provide transmit pulses for delivery through an interconnect to a probe assembly. A flaw 1060 associated with the target can be detected such as by monitoring an impedance or other electrical characteristic associated with respective sensors through in the transducer array.

While FIG. 1 shows a single probe assembly and a single transducer array, other configurations can be used, such as multiple probe assemblies connected to a single test instrument, or multiple transducer arrays used with a single probe assembly. Similarly, a test protocol can be performed using coordination between multiple test instruments, such as in response to an overall test scheme established from a respective test instrument or established by another remote system such as a compute facility 1008 or general-purpose computing device such as a laptop 1032, tablet, smart-phone, desktop computer, or the like.

The front-end circuit 1022 can be coupled to and controlled by one or more processor circuits, such as a processor circuit 1002 included as a portion of the test instrument. The processor circuit can be coupled to a memory circuit 1004, such as to execute instructions that cause the test instrument to perform one or more of EC inspection, processing, or storage of data relating to an EC inspection, or to otherwise perform techniques as shown and described herein. The test instrument can be communicatively coupled to other portions of the system, such as using a wired or wireless communication interface 1020.

The test instrument can include a display 1010, such as for presentation of configuration information or results, and an input device 1012 such as including one or more of a keyboard, trackball, function keys or soft keys, mouse-interface, touch-screen, stylus, or the like, for receiving operator commands, configuration information, or responses to queries.

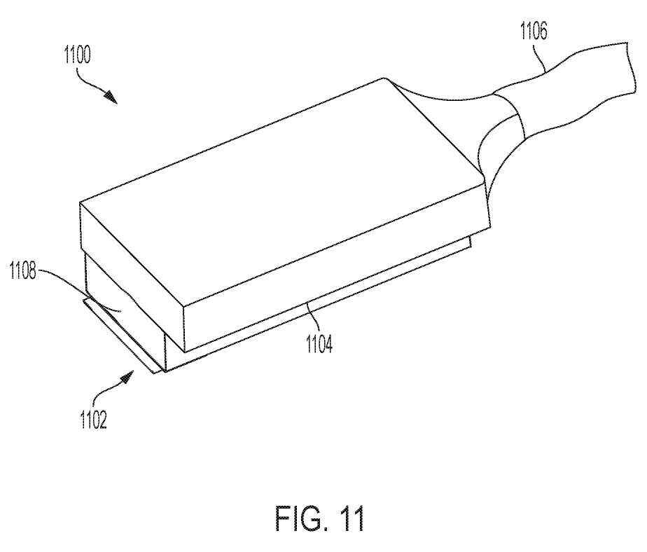

FIG. 11 shows an ECA probe assembly 1100. The probe assembly may include a circuit device 1102 coupled to a probe 1104. The probe may include a connector 1106 for electrically coupling the probe to an acquisition device. The probe may further include a resilient backing 1108. The circuit device may represent any of the embodiments disclosed herein, including variations in substrate materials, coil arrangements, trace routing, and slot configurations.

In FIG. 11, the resilient backing is shown with a cylindrical shape attached to an object-facing surface of the probe. This cylindrical shape of the backing may cause the circuit device, such as the sensing region, to bend in a lateral direction, allowing the sensing region to conform to the contour of an object being tested. The resilient backing may also enable the circuit device to bend longitudinally for conforming to test object surfaces with curvature in multiple directions. In other embodiments, the resilient backing may have different shapes, such as an arc, a saddle, a wedge, a dome, a crescent, a toroid, or a segmented structure, depending on the desired contact profile and flexibility. The backing may be made from materials such as silicone, polyurethane, foam, or other elastomers, selected for their ability to deform and recover shape while providing pressure against the circuit device for conforming to surfaces of a test object.

In some embodiments, the resilient backing may not be positioned directly under the probe as shown in FIG. 11. For example, the backing may extend out from the probe, along with the circuit device, allowing the circuit device to be more freely moved and depressed with the backing into a contour of a test object. This arrangement may provide adaptability for inspecting surfaces with complex or irregular geometries, as the circuit device and backing can be manipulated together to achieve optimal contact and coverage during non-destructive testing.

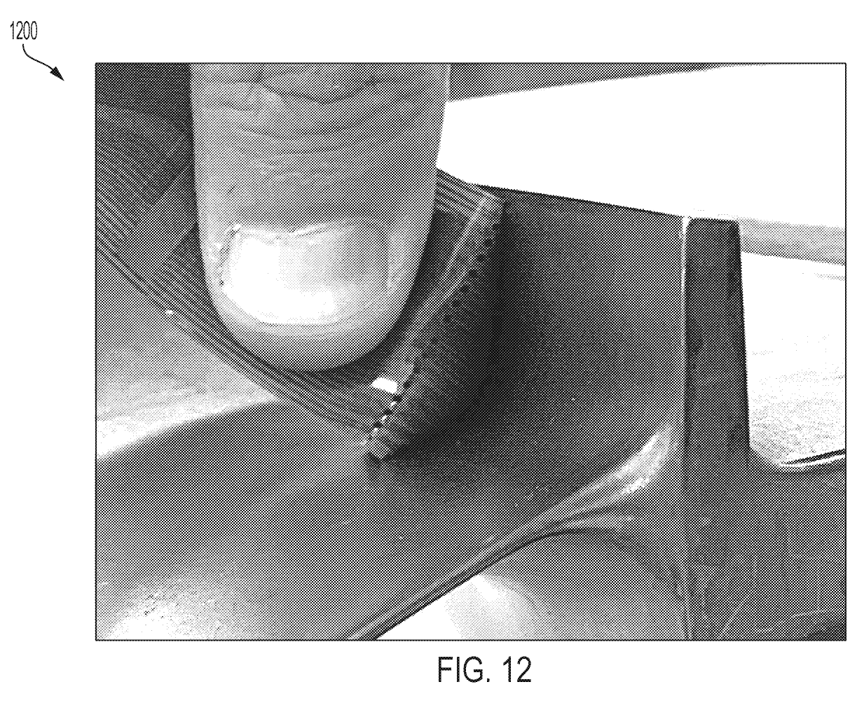

FIG. 12 is an image 1200 showing a printed circuit board of an ECA probe being depressed and bent by a person's hand into a complex area of a test object. The image demonstrates that the printed circuit board, representing an embodiment of the circuit device disclosed herein, is able to conform closely to the surface of the test object, which exhibits curvature in multiple directions. This ability to adapt and maintain contact with complex, curved surfaces highlights the effectiveness of the flexible circuit device design for non-destructive testing applications.

The assembly configurations shown and described in this document and the attached drawings can be used to facilitate non-destructive inspection of structures having a curved contour or shape, such as sharp curvature in two directions at once. Examples of structures having such shape can include turbine blades, such as a shroud region near a root of a high-pressure turbine blade used in a gas turbine engine.

Each of the non-limiting aspects above or in the attached figures can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in a claim are still deemed to fall within the scope of that claim. Moreover, in the following aspects, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following aspects are hereby incorporated into the Detailed Description as examples or embodiments, with each aspect standing on its own as a separate embodiment, and it is contemplated that such embodiments can be combined with each other in various combinations or permutations.

What is claimed is:

1. A circuit device for use with an eddy current array (ECA) probe, the device comprising:
a substrate comprising:
a sensing region at a first end portion of the substrate;
a routing region at a second end portion of the substrate opposite the first end portion; and
an intermediate region extending between the sensing region and the routing region;
an array of coils defined in and arranged laterally along the sensing region;
conductive traces defined in and extending longitudinally along the intermediate and routing regions for coupling the array of coils to a probe connector of the ECA probe; and
longitudinal slots defined in the intermediate region of the substrate between at least some of the conductive traces to mechanically decouple bending of the sensing region from the routing region.

2. The device of claim 1, wherein the array of coils comprises an alternating arrangement of first coils and second coils with portions of the first coils overlapping with portions of the second coils.

3. The device of claim 2, wherein the longitudinal slots and the conductive traces are defined in an alternating arrangement laterally across the intermediate region.

4. The device of claim 2, wherein the first coils and second coils are colinearly aligned.

5. The device of claim 2, wherein:
the sensing region of the substrate comprises multiple sensing region layers, the coils comprise coil traces;
the coil traces of the first coils are defined in a first subset of the sensing region layers; and
the coil traces of the second coils are defined in a second subset of the sensing region layers.

6. The device of claim 5, wherein the first subset of the sensing region layers comprises two layers, and the second subset of the sensing region layers comprises two layers positioned between the two layers of the first subset.

7. The device of claim 5, wherein the intermediate region of the substrate comprises fewer layers than the sensing region.

8. The device of claim 1, wherein each coil of the array is coupled to a pair of the conductive traces, and the conductive traces of the pair extend along adjacent layers of the intermediate region in an overlapping arrangement.

9. The device of claim 8, wherein no more than two pairs of conductive traces are positioned between adjacent longitudinal slots.

10. The device of claim 1, wherein the sensing region comprises:
a sensing region width extending longitudinally from an edge of the first end of the substrate to the intermediate region; and
a sensing region length extending along the edge of the first end of the substrate, and the sensing region length is at least 5 times greater than the sensing region width.

11. The device of claim 1, wherein the intermediate region comprises an intermediate width equal to a length of the longitudinal slots and extending longitudinally from the sensing region to the routing region, the intermediate region width is at least 3 times greater than the sensing region width.

12. The device of claim 1, wherein the longitudinal slots comprise:
curved terminal ends; and
elongated portions intermediate the curved terminal ends, and the curved terminal ends are wider than the elongated intermediate portions.

13. An eddy current array (ECA) sensing assembly, comprising:
a probe comprising:
a circuit board comprising an array of coils; and
a resilient backing positionable against a surface of the circuit board; and
an acquisition device operatively couplable with the array of coils to implement a determined timed coil‑stimulation sequence and acquire corresponding eddy‑current signals, wherein the circuit board further comprises:
a substrate, comprising:
a sensing region at a first end portion of the substrate, wherein the array of coils is defined in and arranged laterally along the sensing region;
a routing region at a second end portion of the substrate opposite the first end portion; and
an intermediate region extending between the sensing region and the routing region;
conductive traces defined in and extending longitudinally along the intermediate and routing regions for coupling the array of coils to the acquisition device; and
longitudinal slots defined in the intermediate region of the substrate between at least some of the conductive traces, wherein the resilient backing is configured to bend the sensing region of the substrate to conform to a contour of a test object.

14. The ECA sensing assembly of claim 13, wherein the array of coils comprises an alternating arrangement of first coils and second coils with portions of the first coils overlapping with portions of the second coils, and the first coils and the second coils are colinearly aligned.

15. The ECA sensing assembly of claim 14, wherein the longitudinal slots and the conductive traces are defined in an alternating arrangement laterally across the intermediate region.

16. The ECA sensing assembly of claim 13, wherein:
the sensing region of the substrate comprises multiple sensing region layers;
the coils comprise coil traces, the coil traces of the first coils are defined in a first subset of the sensing region layers; and
the coil traces of the second coils are defined in a second subset of the sensing region layers.

17. The ECA sensing assembly of claim 16, wherein the first subset of the sensing region layers comprises two layers, and the second subset of the sensing region layers comprises two layers positioned between the two layers of the first subset.

18. The ECA sensing assembly of claim 16, wherein the intermediate region of the substrate comprises fewer layers than the sensing region.

19. The ECA sensing assembly of claim 13, wherein each coil of the array is coupled to a pair of the conductive traces, and the conductive traces of the pair extend along adjacent layers of the intermediate region in an overlapping arrangement.

20. The ECA sensing assembly of claim 13, wherein the sensing region comprises:
a sensing region width extending longitudinally from an edge of the first end of the substrate to the intermediate region; and
a sensing region length extending along the edge of the first end of the substrate, wherein the intermediate region comprises an intermediate width equal to a length of the longitudinal slots and extending longitudinally from the sensing region to the routing region, and the intermediate region width greater than one third of the sensing region length.

21. A circuit device for use with an eddy current array (ECA) probe, the device comprising:
a substrate comprising:
a sensing region at a first end portion of the substrate;
a routing region at a second end portion of the substrate opposite the first end portion; and
an intermediate region extending between the sensing region and the routing region;
an array of coils defined in the sensing region;
conductive traces defined in and extending along the intermediate and routing regions for coupling the array of coils to a probe connector of the ECA probe; and
longitudinal slots defined in the intermediate region of the substrate, wherein a resilient backing of the ECA probe is configured to bend the sensing region of the substrate to conform to a contour of a test object.
